(19) United States
(12) Patent Application Publication
(10) Pub. No.: US 2012/0099709 A1
(43) Pub. Date: Apr. 26, 2012

(54) DEVICE AND METHOD TO GENERATE X-RAY RADIATION WITH TWO SPECTRA

(76) Inventors: Stefan Thesen, Dormitz (DE); Marcus Wagner, Obermichelbach (DE)

(21) Appl. No.: 13/277,394

(22) Filed: Oct. 20, 2011

(30) Foreign Application Priority Data
Oct. 20, 2010 (DE) 10 2010 042 683.0

(51) Int. Cl. G21K 3/00

(52) U.S. Cl. 378/156

(57) ABSTRACT

In a device, a method and a computer-readable storage medium encoded with programming instructions to generate x-ray radiation to examine a subject with at least two spectra respectively of x-ray radiation of different average photon energies, an x-ray tube is used that has at least two foci that are different from one another, and the device is operated to switch between the foci in order to generate x-ray radiation. A spectrum of x-ray radiation respectively emanates from each focus. A filter is associated with the x-ray tube such that the spectrum of x-ray radiation emanating from one of the foci is not filtered by the filter and the spectrum of x-ray radiation emanating from another of the foci is filtered by the filter, such that the average photon energy of the filtered spectrum of x-ray radiation is higher than the average photon energy of the unfiltered spectrum of x-ray radiation.

### BACKGROUND OF THE INVENTION

1. Field of the Invention

The invention concerns a device and a method to generate x-ray radiation to examine a subject with at least two spectra of x-ray radiation, respectively of different average photon energies. The invention also concerns a non-transitory computer-readable storage medium encoded with programming instructions for implementing such a method, when the storage medium is loaded in a computer.

2. Description of the Prior Art

In x-ray technology, particularly in x-ray computed tomography, there are various approaches to scan an examination subject (a patient, for example) with spectra of x-ray radiation of different average photon energies in order to be able to identify different tissue types or their chemical composition, for example based on the energy-dependent absorption of x-ray radiation by tissue.

For example, a computed tomography apparatus (CT scanner) is commercially available from Siemens AG with the designation “SOMATOM Definition” that has two x-ray systems each having an x-ray tube and an x-ray detector arranged on a gantry. In the course of a “dual-energy scan”, one x-ray tube can be operated with a relatively low tube voltage (of 80 kV, for example) and the other x-ray tube can be operated with a relatively high tube voltage (of 140 kV, for example). In this way, with the two x-ray systems, two data sets of measurement signals are acquired that have different degrees of absorption of x-ray radiation due to the spectra of different average photon energies that respectively emanate from the two x-ray tubes.

As an alternative to such a computed tomography apparatus having two x-ray systems, there is the approach of operating a computed tomography apparatus with only one x-ray system having an x-ray tube to generate spectra of x-ray radiation of different average photon energies such that a relatively low tube voltage (of 80 kV, for example) and a relatively high tube voltage (of 140 kV, for example) are alternately applied to the x-ray tube. The switching interval for alternating application of the relatively low voltage and relatively high voltage can amount to approximately 300 μs, for example.

However, the switching interval duration cannot be arbitrarily shortened since the x-ray tube and the high voltage generator associated with the x-ray tube have a certain inertia (time lag) that prevents the desired voltage from being reached immediately at a respective switching point in time. This fact leads to limitations in the application of the method of switching the tube voltage, since the inertia cannot be tolerated for some applications, for example applications in which x-ray contrast agent is administered to a patient (for example in order to be able to reveal vessels conducting blood with x-ray radiation). During the scan (the acquisition of x-ray projections) with alternating tube voltage, the concentration of the injected contrast agent in a vessel may have changed in the course of the scan (which runs slowly due to the switching of the voltage) such that the originally desired information (based on the scan with two spectra of x-ray radiation of different average photon energy) can no longer be derived from the measurement signals.

DE 10 2004 031 169 A1 discloses an alternative to switching the tube voltage. This document discloses computed tomography apparatus with an x-ray tube with a beam path in which a filter with two different filter halves is arranged, such that the beam fan emanating from the x-ray source is divided into a first partial beam fan with a first spectrum of x-ray radiation and a second partial beam fan with a second spectrum of x-ray radiation different than the first. A comparable arrangement is also described in U.S. Pat. No. 4,255,664 and in U.S. Pat. No. 5,570,403.

### SUMMARY OF THE INVENTION

An object of the present invention is to provide a device and a method to generate x-ray radiation, and a non-transitory computer-readable data medium with which at least two spectra of x-ray radiation of different average photon energies can be generated using an x-ray tube for examination of a measurement subject.

According to the invention, this object is achieved by a device and a method to generate x-ray radiation to examine a measurement subject with at least two spectra of x-ray radiation of different average photon energies. The device has at least one x-ray tube having at least two foci that are different from one another; the device being operated to switch between the foci to generate x-ray radiation, with a spectrum of x-ray radiation respectively emanating from each foci. The device has a filter associated with the at least one x-ray tube such that the spectrum of x-ray radiation emanating from the first focus is not filtered by the filter and the spectrum of x-ray radiation emanating from the second focus is filtered by the filter. The filter makes the average photon energy of the filtered spectrum of x-ray radiation higher than the average photon energy of the unfiltered spectrum of x-ray radiation emanating from the first focus.

The x-ray tube according to the invention uses what is known as a “jump focus” or “flying focal spot”. For example, in the case of use in a computed tomography apparatus, the x-ray tube has two foci that are offset relative to one another in the direction of the system axis, namely in the direction of the z-axis of the computed tomography apparatus, on the anode of the x-ray tube. The realization of the two foci is technically achieved by an electron beam emanating from a cathode of the x-ray tube being selectively deflected to the first focus and selectively deflected to the second focus. A spectrum of x-ray radiation respectively emanates from each if the foci. The two spectra are essentially identical with regard to their average photon energy. However, the two spectra of x-ray radiation are emitted in different spatial directions as a result of their differing points of origin (the two foci). The use of a “flying focal spot” thereby has the advantage that a very fast switching between the two foci (and thus the two spatial directions) is possible. For example, the switching interval can be 200 μs or even less, depending on the capability of the beam deflection unit.

As noted, a filter for x-ray radiation is associated with the x-ray tube at a location such that the spectrum of x-ray radiation emanating from a first focus propagates outside the filter and thus is not filtered, while the spectrum of x-ray radiation emanating from the second focus must pass through the filter, and thus is filtered by the filter. The filter is designed such that the spectrum of the x-ray radiation emanating from the second focus has a higher average photon energy after the filtering.

With the described device, in order to acquire measurement data from a subject, it is thus possible to alternately generate two spectra of x-ray radiation with different average photon energy by an alternating activation of the two foci, with a consistent (unchanging) voltage applied to the x-ray tube. The change between the two spectra can take place fast enough so that, for example, CT scans using contrast agent—for example CT angiography scans, of the type known as “dual-energy scans”—can be implemented without any problems.

According to one variant of the invention, the filter associated with the x-ray tube or the foci thereof includes tin. The filter can be fashioned entirely of tin. The tin filter located in the beam path of the x-ray radiation emanating from the second focus has the effect that the x-ray quanta of the emitted spectrum of x-ray radiation with a low photon energy are absorbed in the tin filter, i.e., are filtered by the tin filter. In contrast, the high-energy portion of the spectrum of x-ray radiation can pass through the tin filter. In this way the filtered spectrum of x-ray radiation has a higher average photon energy than the spectrum of x-ray radiation emitted by the first focus.

In an embodiment of the invention, at least two tube voltages that are different from one another can be applied to the at least one x-ray tube, so it is possible to switch between the at least two different tube voltages, with a higher tube voltage being applied to the at least one x-ray tube in the operation of the second focus than in the operation of the first focus. This embodiment of the invention is particularly suitable for applications in which the switching procedure or the time for the switching procedure of the tube voltage can be accepted during a scan, i.e., during the acquisition of x-ray projections. In this variant of the invention, the use of two tube voltages allows two spectra of x-ray radiation to be generated that are more distinctly separate from one another with regard to their average photon energy compared to the use of only one tube voltage. In addition to the energy selection, the filter also produces a reduction of the intensity of the x-ray radiation of the spectrum of x-ray radiation generated at the higher tube voltage. This is advantageous since the speed of the adaptation of the tube current of the x-ray tube is also limited, particularly upon changing from the lower tube voltage to the higher tube voltage. Therefore, the intensity of the x-ray radiation of the spectrum of x-ray radiation generated at the higher tube voltage is also decreased by the filter, given unregulated or uncontrolled tube current with regard to the switching of the voltage.

In an embodiment of the invention, the thickness of the filter is selected depending on a maximum tube current of the at least one x-ray tube.

The above object also is achieved in accordance with the present invention by a non-transitory computer-readable data storage medium encoded with programming instructions. The programming instructions, when the storage medium is loaded in a computerized control device of an x-ray imaging system, cause the above-described method to be implemented by the system.

### BRIEF DESCRIPTION OF THE DRAWINGS

FIG. 1 schematically illustrates a computed tomography apparatus for examination of a patient.

FIG. 2 schematically illustrates the generation of two spectra of x-ray radiation of different average photon energies.

FIGS. 3 and 4 respectively show two spectra of x-ray radiation of different average photon energies.

### DESCRIPTION OF THE PREFERRED EMBODIMENTS

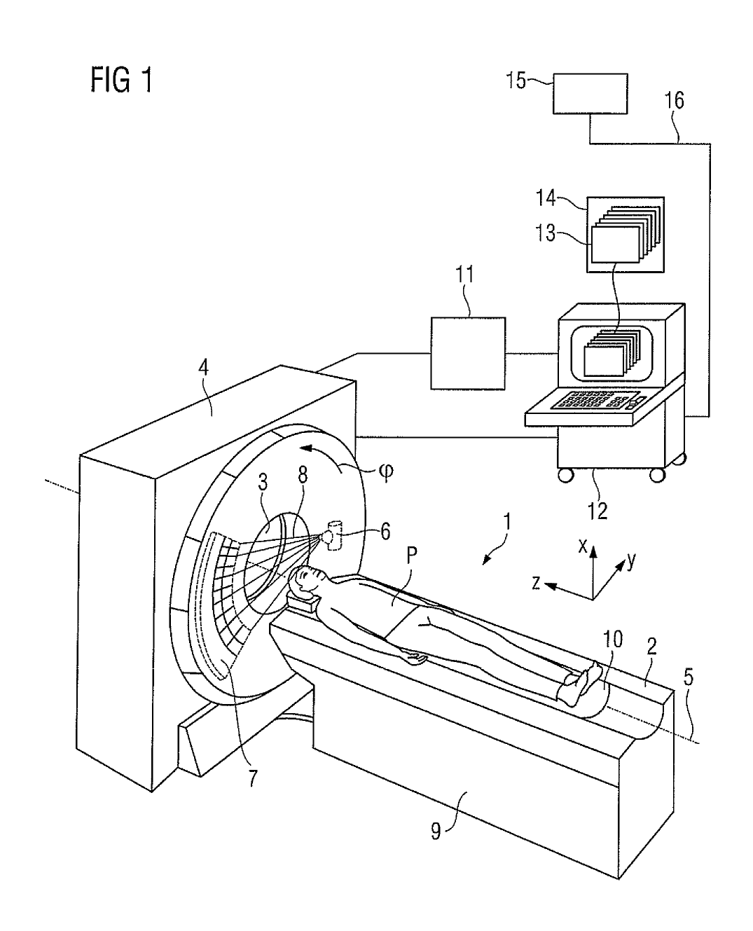

Identical or functionally identical elements, components, tissue etc. are necessarily provided with the same reference characters in the figures. The representations in the figures are schematic and not necessarily true to scale, and scales can vary between the figures. The computed tomography apparatus 1 shown in FIG. 1 is described in the following, and without limitation of generality only insofar as necessary to understand the invention.

The computed tomography apparatus 1 shown in FIG. 1 has a patient bed 2 to support a patient P to be examined. The computed tomography apparatus 1 also has a gantry 4 with a tube/detector system mounted such that it can rotate around a system axis 5, namely the z-axis. The tube/detector system is formed by an x-ray tube 6 and an x-ray detector unit 7 situated opposite one another. In operation, x-ray radiation 8 emanates from the x-ray tube 6 in the direction of the x-ray detector unit 7 and is detected by the x-ray detector unit 7 in the form of measurement signals.

The patient bed 2 has a bed base 9 on which a patient support plate 10 is mounted to actually support the patient P. The patient support plate 10 is adjustable relative to the bed base 9 such that the patient support plate 10 with the patient P can be introduced into the opening 3 of the gantry 4 to acquire 2D x-ray projections of the patient P, for example in a spiral scan. The computational processing of the 2D x-ray projections (the reconstruction of slice images and/or of a volume data set of a body region of the patient P) based on the 2D x-ray projections takes place with a schematically depicted image computer 11 of the computed tomography apparatus 1.

In the illustrated exemplary embodiment of the invention, an examination of the heart of the patient P takes place with the computed tomography apparatus 1 in the form of a CIA (CT angiography) in which a contrast agent (containing iodine, for example) is administered to the patient P in a blood-carrying vessel. The examination should be implemented as a “dual-energy” scan”, meaning that the body region of the patient P that include the heart of the patient P should be scanned with two spectra of x-ray radiation of different average photon energy. The scan or the acquisition of 2D x-ray projections of the heart of the patient from different directions preferably is implemented as a spiral scan. From the acquired 2D x-ray projections (the measurement signals thereof), slice images of the heart are reconstructed by the image computer 11, or a volume data set of the heart of the patient is reconstructed by the image computer 11.

In order to be able to generate such measurement signals using only one x-ray tube 6, the x-ray tube 6 has two foci (two focal points) on the anode of the x-ray tube 6 (the anode is not shown in the figures). In the illustrated exemplary embodiment of the invention, the x-ray tube 6 is arranged in the gantry 4 such that the two foci have an offset in the direction of the system axis 5 (the z-axis) on the anode of the x-ray tube 6. Technically, the two foci are realized by an electron beam emanating from a cathode of the x-ray tube (the cathode likewise not being shown in the figures) being selectively deflected back and forth from one focus to the other focus for x-ray generation. A spectrum of x-ray radiation respectively emanates from each focus. The two spectra in this embodiment are essentially identical. This principle is also generally known as a jump focus or “flying focal spot” in x-ray tubes.

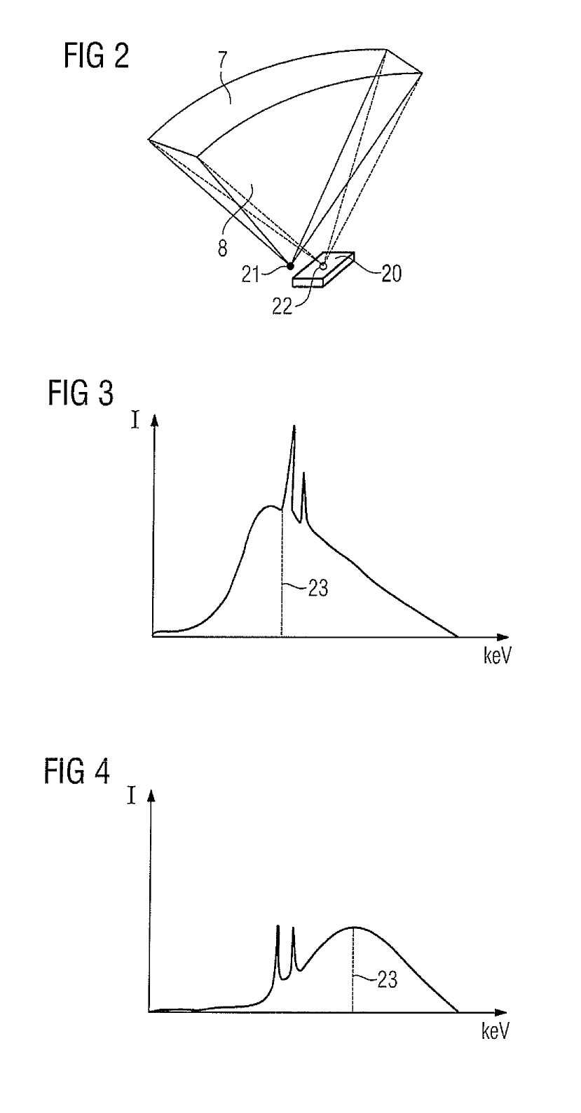

Furthermore, in the exemplary embodiment of the invention a filter 20 made of tin is associated with the x-ray tube 6 or the two foci 21, 22 of the x-ray tube 6, as is schematically shown in FIG. 2. The x-ray tube 6 and the two foci 21, 22 and the filter 20 are arranged relative to one another such that the x-ray radiation emanating from the first focus 21 is not filtered by the filter 20 (does not pass through the filter 20), such that the spectrum of the x-ray radiation emanating from the focus 21 is unchanged with by the filter 20. The spectrum of x-ray radiation emanating from the focus 21 is illustrated in FIG. 3. After passing through the patient P, the x-ray radiation emanating from the first focus 21 strikes the x-ray detector 7, as is schematically shown in FIG. 2.

By contrast, the x-ray radiation emanating from the second focus 22 must pass through the filter 20 and thus is filtered by the filter 20, so that the spectrum of x-ray radiation from the focus 22, which originally was identical in this embodiment to the spectrum shown in FIG. 2, is altered. The tin filter 22 has the effect that relatively low-energy x-ray radiation (x-ray quanta) are absorbed in the filter 20 so that the spectrum of x-ray radiation from the focus 22 (illustrated in FIG. 4) results. By comparison of the spectra of x-ray radiation that are shown in FIG. 3 and FIG. 4 it can be seen that the average photon energy, indicated by the dashed line 23, of the filtered spectrum is higher than that of the unfiltered spectrum. The requirements to acquire x-ray exposures with two spectra of x-ray radiation of different average photon energies are thereby satisfied by the device having the x-ray tube 6 and the filter 20. After passing through the patient P, the x-ray radiation emanating from the second focus 22 also strikes the x-ray detector 7, as is schematically depicted with dashed lines in FIG. 2.

In the course of the “dual-energy scan” of the patient P, 2D x-ray projections of the body region of the patient P that includes the heart can accordingly be acquired with the two spectra of x-ray radiation of different average photon energies from different directions at essentially the same position of the x-ray system relative to the patient P, using the technique of the flying focus 21, 22 and the tin filter 20. The 2D x-ray projections acquired for each spectrum of x-ray radiation are subsequently processed by the image computer 11, which reconstructs slice images or a volume data set for each spectrum of x-ray radiation. Furthermore, additional evaluations are possible in order (for example) to identify specific tissue or tissue compositions.

In the exemplary embodiment of the invention, the image computer 11 is connected with a computer 12 of the computed tomography apparatus, in the exemplary embodiment of the invention, is a control and operating unit of the computed tomography apparatus and has a computer program 13 that realizes the described operating method to generate two spectra of x-ray radiation of different average photon energy. The computer program 13 can be loaded into the computer from a portable, non-transitory data storage medium 13 (for example a CD or a memory stick) or from a server 15 (which can also be considered a data medium for the computer program 13) via a network 16. The network 16 does not need to be a network that is completely internal to the hospital, but can be partially formed by the Internet or another public network, for example. The computer program can be selected and started in an acquisition mode at the computer 12. Among other things, the frequency for the changing of the focus is thereby established in the computer program.

In another embodiment of the invention the tube voltage applied to the x-ray tube 6 is also varied (changed) upon changing between the foci 21, 22. In the exemplary embodiment of the invention schematically shown in FIG. 2, a tube voltage of 80 kV is applied to the x-ray tube 6 synchronously with the operation of the focus 21, and a tube voltage of 140 kV is applied to the x-ray tube 6 synchronously with the operation of the focus 22. In addition to a markedly better separation of the two spectra of x-ray radiation with regard to their average photon energy, in operation of the second focus 22—in which the high tube voltage is applied to the x-ray tube 6—high-energy photons are additionally filtered out of the spectrum by the filter 20 so that the patient P is not exposed with an unnecessarily high dose of x-ray radiation. This effect is of importance since the tube current cannot be simultaneously adapted given the respective change of the tube voltage, i.e. it cannot be reduced in order to reduce the dose in the event of the change to the higher voltage.

For this operating mode, the thickness of the filter in the direction of the propagation of the x-ray radiation toward the x-ray detector 7, and therefore its absorption property, is adapted to the maximum tube current, such that the dose of x-ray radiation applied to the patient can be lowered.

In contrast to the described exemplary embodiments of the invention, different voltages can be applied to the x-ray tube.

Furthermore, the focus could also be deflected in a different direction than the z-direction—for example in the φ-direction (see FIG. 1), thus essentially in the rotation direction of the gantry—in order to obtain two foci that are operated in alternation.

Moreover, the x-ray tube could also have more than two foci with which filters are correspondingly associated or not associated.

Although modifications and changes may be suggested by those skilled in the art, it is the intention of the inventors to embody within the patent warranted hereon all changes and modifications as reasonably and properly come within the scope of their contribution to the art.

We claim as our invention:

1. A system to generate x-ray radiation comprising:
an x-ray tube having at least two foci that are different from each other;
a control device configured to operate the x-ray tube to cause x-ray radiation to be emitted from each of said at least two foci, with each of said at least two foci emitting said x-ray radiation with a radiation spectrum; and
a filter located with respect to said at least two foci so that the spectrum of x-ray radiation from a first focus among said at least two foci is not filtered by said filter and the spectrum of x-ray radiation from a second focus among said at least two foci is filtered by said filter, said filter causing an average photon energy of the filtered spectrum of x-ray radiation from said second focus to be higher than an average photon energy of the unfiltered spectrum of the unfiltered spectrum of x-ray radiation from said first focus.

2. A system as claimed in claim 1 wherein said filter is comprised of tin.

3. A system as claimed in claim 1 wherein said filter consists of tin.

4. A system as claimed in claim 1 wherein said control device is configured to operate said x-ray tube to cause said x-ray radiation to be respectively emitted from said at least two foci with substantially identical spectra.

5. A system as claimed in claim 1 wherein said x-ray tube operates with a tube voltage, and wherein said control device is configured to apply at least two different tube voltages to said x-ray tube, with a higher tube voltage being applied to said x-ray tube during emission of said x-ray radiation from said second focus than during emission of x-ray radiation from said first focus.

6. A system as claimed in claim 1 wherein said control device is configured to operate said x-ray tube with a maximum tube current, and wherein said filter has a thickness that is dependent on said maximum tube current.

7. A system as claimed in claim 1 wherein said control device is configured to operate said x-ray tube according to a jump focus technique.

8. A method to generate x-ray radiation comprising:
providing an x-ray tube having at least two foci that are different from each other;
from a control device, operating the x-ray tube to cause x-ray radiation to be emitted from each of said at least two foci, with each of said at least two foci emitting said x-ray radiation with a radiation spectrum; and
selectively filtering said x-ray radiation from said at least two foci with a filter located with respect to said at least two foci so that the spectrum of x-ray radiation from a first focus among said at least two foci is not filtered by said filter and the spectrum of x-ray radiation from a second focus among said at least two foci is filtered by said filter, and thus by said filtering causing an average photon energy of the filtered spectrum of x-ray radiation from said second focus to be higher than an average photon energy of the unfiltered spectrum of the unfiltered spectrum of x-ray radiation from said first focus.

9. A method as claimed in claim 8 comprising forming said filter of tin.

10. A method as claimed in claim 8 comprising forming said filter exclusively of tin.

11. A method as claimed in claim 8 comprising, from said control device, operating said x-ray tube to cause said x-ray radiation to be respectively emitted from said at least two foci with substantially identical spectra.

12. A method as claimed in claim 8 wherein said x-ray tube operates with a tube voltage and, from said control device is, causing at least two different tube voltages to be supplied to said x-ray tube, with a higher tube voltage being applied to said x-ray tube during emission of said x-ray radiation from said second focus than during emission of x-ray radiation from said first focus.

13. A method as claimed in claim 8 comprising, from said control device operating said x-ray tube with a maximum tube current, and comprising editing a thickness of said filter dependent on said maximum tube current.

14. A method as claimed in claim 8 comprising, from said control device, operating said x-ray tube according to a jump focus technique.

15. A non-transitory, computer-readable storage medium encoded with programming instructions, said storage medium being loaded into a computerized control unit of an x-ray imaging system that comprises an x-ray tube having at least two foci, and a filter, said programming instructions causing said computerized control unit to operate said x-ray imaging system to:
cause x-ray radiation to be emitted from each of said at least two foci, with each of said at least two foci emitting said x-ray radiation with a radiation spectrum; and
filter said x-ray radiation with a filter located with respect to said at least two foci so that the spectrum of x-ray radiation from a first focus among said at least two foci is not filtered by said filter and the spectrum of x-ray radiation from a second focus among said at least two foci is filtered by said filter, said filter causing an average photon energy of the filtered spectrum of x-ray radiation from said second focus to be higher than an average photon energy of the unfiltered spectrum of the unfiltered spectrum of x-ray radiation from said first focus.
